(19) United States
(12) Patent Application Publication
(10) Pub. No.: US 2026/0027960 A1
(43) Pub. Date: Jan. 29, 2026

(54) VEHICLE INCLUDING STORAGE SYSTEM UNDER TILT BED

(71) Applicant: Honda Motor Co., Ltd., Tokyo (JP)

(72) Inventor: Mekenna A. SCHEITLIN, Dublin, OH (US)

(21) Appl. No.: 18/782,609

(22) Filed: Jul. 24, 2024

(51) Int. Cl. B60P 1/28

(52) U.S. Cl. CPC B60P 1/283

(57) ABSTRACT

A vehicle can include a frame assembly, a tilt bed pivotally connected to the frame assembly, and a storage bin. The tilt bed can be movable between a lowered position and a dump position different from the lowered position. The storage bin can be located underneath the tilt bed in a vertical direction of the vehicle, and can include base and a lid pivotally connected to the base. The lid can be pivot between a closed position where the lid closes the opening, and an opened position where the lid exposes the opening. The tilt bed can be configured to impede movement of the lid into the opened position if the tilt bed is in the lowered position, and to permit the lid to move into the opened position if the tilt bed is in the dump position.

### BACKGROUND

The disclosed subject matter relates to a vehicle including a storage system. More particularly, the disclosed subject matter relates to a vehicle that includes a tilt bed and a storage bin underneath the tilt bed.

An off-road vehicle can include a tilt bed that is configured to carry material such as, but not limited to, dirt, gravel, farming materials, farming equipment, hunting equipment, and harvested game. The tilt bed can be pivotally connected to the chassis of the vehicle so that the contents in the bed can be removed by inclining the tilt bed relative to the chassis into a dump position in which the rear end of the tilt bed is lower that the front end of the tilt bed in a vertical direction of the vehicle. The tilt bed can include a gate that selectively opens and closes the rear end of the tilt bed by pivoting as the tilt bed pivots or after the tilt bed has moved to or from the dump position.

### SUMMARY

Some embodiments are directed to a vehicle that can include a frame assembly, a tilt bed pivotally connected to the frame assembly, and a storage bin. The tilt bed can be movable between a lowered position where the front end has a first orientation relative to frame assembly, and a dump position where the tilt bed has a second orientation relative to the frame assembly, where the second orientation is different from the first orientation. The storage bin can be located underneath the tilt bed in a vertical direction of the vehicle. The storage bin can include a base mounted onto the frame assembly and a lid pivotally connected to the base. The base can includes a storage space and an opening. The lid can pivot between a closed position where the lid closes the opening, and an opened position where the lid exposes the opening. The tilt bed can be configured to impede movement of the lid into the opened position if the tilt bed is in the lowered position, and to permit the lid to move into the opened position if the tilt bed is in the dump position.

Some embodiments are directed to a vehicle that can include a frame assembly, a tilt bed pivotally mounted to the frame assembly, and a storage bin. The tilt bed can be pivotable between a lowered position where the front end has a first orientation relative to frame assembly, and a dump position where the tilt bed has a second orientation relative to the frame assembly, where the second orientation is different from the first orientation. The storage bin can be mounted onto the frame assembly and include a base and a lid pivotally connected to the base. The base can be mounted onto the frame assembly and underneath the tilt bed in a vertical direction of the vehicle. The base can include a storage space and an opening. The lid can be pivoted between a closed position where the lid closes the opening, and an opened position where the lid exposes the opening. The tilt bed can be configured to impede movement of the lid into the opened position if the tilt bed is in the lowered position, and to permit movement of the lid into the opened position if the tilt bed is in the dump position.

Some embodiments are directed to a vehicle can include a frame assembly, a pair of front wheels suspended from the frame assembly, a pair of rear wheels suspended from the frame assembly, at least one seat supported by the frame assembly, a power source mounted onto the frame assembly, a tilt bed that is pivotally connected to the frame assembly, and a first storage bin mounted on the frame assembly. The front wheels can be spaced away from each other in a transverse direction of the vehicle. The rear wheels can be spaced away from each other in a transverse direction of the vehicle, and spaced away from the pair of front wheels in a longitudinal direction of the vehicle. The power source can be mounted located between the seat and the pair of rear wheels in the longitudinal direction, and connected to at least one of the wheels. The tilt bed that can be stacked above the power source in a vertical direction of the vehicle. The tilt bed can be pivoted between a lowered position where tilt bed has a first orientation relative to the frame assembly, and a dump position where the tilt bed has a second orientation relative to the frame assembly, where the second orientation is different from the first orientation. The first storage bin can be underneath the tilt bed in the vertical direction. The first storage bin can include a first base and a first lid. The first base can be mounted onto the frame assembly and underneath the tilt bed in the vertical direction, and can include a first storage space and a first opening. The first lid can be pivotally connected to the first base and movable between a closed position where the first lid closes the first opening and an opened position where the first lid exposes the first opening. The tilt bed can be configured to impede movement of the first lid into the opened position if the tilt bed is in the lowered position, and configured to permit movement of the first lid into the opened position if the tilt bed is in the dump position.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a side view of a vehicle made in accordance with principles of the disclosed subject matter.

FIG. 2 is a side perspective view of the vehicle of FIG. 1 with the tilt bed in the inclined position.

FIG. 3 is a side perspective view of the vehicle of FIG. 1 with the tilt bed, wheels and power source omitted.

FIG. 4 is a perspective view of a storage bin of the vehicle of FIG. 1.

FIG. 5 a perspective view of the storage bin of FIG. 4 with the lid in the opened position.

FIG. 6 is top view of the storage bin of FIG. 4.

FIG. 7 is a bottom view of the storage bin of FIG. 4.

FIG. 8 is a left side view of the storage bin of FIG. 4.

FIG. 9 is a right side view of the storage bin of FIG. 4.

FIG. 10 is a rear view of the storage bin of FIG. 4.

FIG. 11 is a front view of the storage bin of FIG. 4

FIG. 12 is a top view of a base of the storage bin of FIG. 4.

FIG. 13 is a partial cross-section view of the storage bin of FIG. 4 showing the latch receptacle of the base and the latch of the lid.

FIG. 14 is a partial plan view of the latch receptacle of the storage bin of FIG. 4.

FIG. 15 is a partial perspective view of the latch of the storage bin of FIG. 4.

FIG. 16. a partial perspective view of the storage bin of FIG. 4 showing the hinge assembly.

FIG. 17 is a cross-sectional view taken along line 17-17 of FIG. 16.

FIG. 18 is an enlarged portion of FIG. 3.

FIG. 19 is an enlarged portion of FIG. 2.

FIG. 20 is a cross-sectional view taken along line 20-20 of FIG. 6.

FIG. 21 is a perspective view of an alternate embodiment of a storage bin.

FIG. 22 is a partial perspective view of the storage bin of FIG. 21 and showing a hinge and latching assembly.

FIG. 23 is a top perspective view of an upper portion of the frame assembly of the vehicle of FIG. 1.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

An off-road vehicle can include a chassis that is built from a plurality of tubes that are connected together by any appropriate manner such as, but not limited to, threaded fasteners, rivets, clamps, clips, welds, adhesives, or any combination of the connecting structures. The chassis can be referred to as a frame assembly, a tube frame chassis, a tube frame, or a space frame. The off-road vehicle can include one or more body panels that cover all of or only a portion of the frame assembly. For example, the off-road vehicle can include body panels that cover a front end portion of the frame assembly, at least one floor panel in a passenger space and a plurality of doors that at least partially cover an opening to the passenger space. The portion of the chassis that extends from the passenger space to the rear end of the frame assembly can be uncovered. The off-road vehicle can include enclosed storage space under the passenger seats and in at least one of the panels at the front of the vehicle. A tilt bed can be located over the portion of the chassis that extends from the passenger space to the rear end of the frame assembly.

It can be advantageous to provide an additional enclosed storage space. For example, it can be advantageous to provide the additional enclosed storage space behind the passenger space and underneath the tilt bed. This location can be desirable because the enclosed storage space does not adversely impact the passenger comfort in the passenger space and the enclosed storage space does not interfere with the operation of the tilt bed.

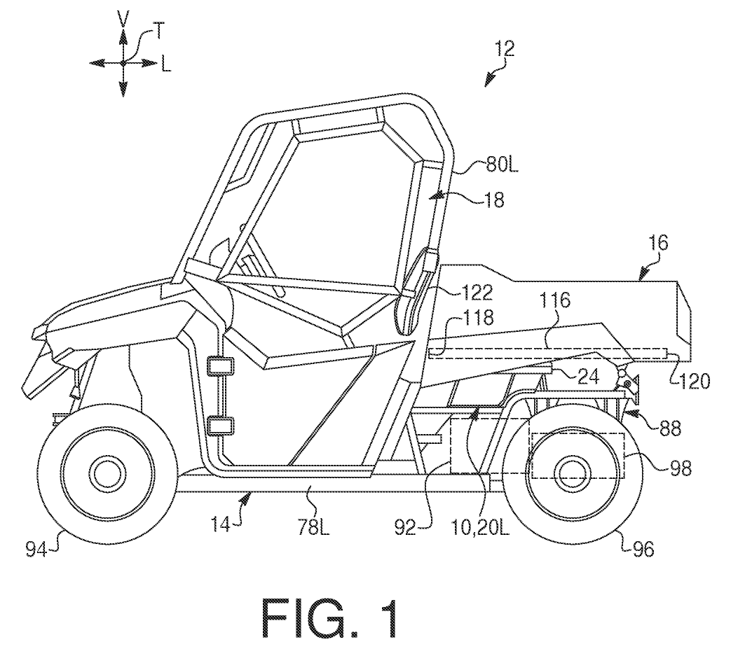

FIGS. 1-3 illustrate a storage system 10 for a vehicle 12 made in accordance with principles of the disclosed subject matter. The vehicle 12 can include a longitudinal direction L, a transverse direction T and vertical direction V, and the directions L, T, V can be orthogonal to each other. The vehicle 10 shown in FIG. 1 can be specialized for use on an unimproved path or on an unmarked path, and can be referred to as a multipurpose utility vehicle (MUV) or as a side-by-side all-terrain vehicle (SxS, or SxS ATV). The storage system 10 can include at least one enclosed storage space that can be sealed against dirt, debris and fluids. Thus, the storage system 10 can be advantageous for a vehicle 12 that is configured to operate off-road and in muddy, wet and/or dusty environments.

However, the disclosed storage system can be used with any vehicle that is configured for travel along any one or combination of improved, unimproved, and unmarked paths.

The vehicle 12 can include a frame assembly 14 and a tilt bed 16. At least a portion of the frame assembly 14 can form a passenger space 18. The storage system 10 can be mounted onto the frame assembly 14 at a location that is rearward of the passenger space 18 in the longitudinal direction L and underneath the tilt bed 16 in the vertical direction V. The storage system 10 can provide at least one additional enclosed storage space that is outside of the passenger space 18 and outside of the range of motion for the tilt bed 16.

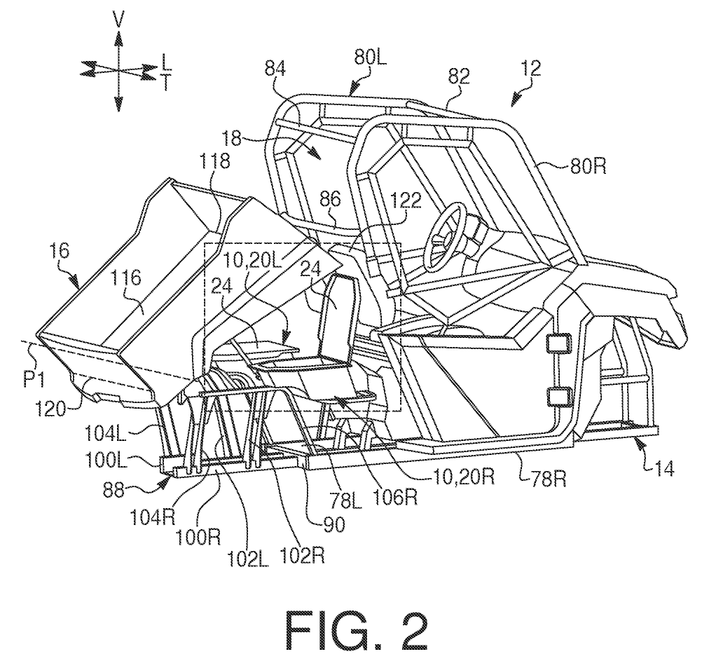

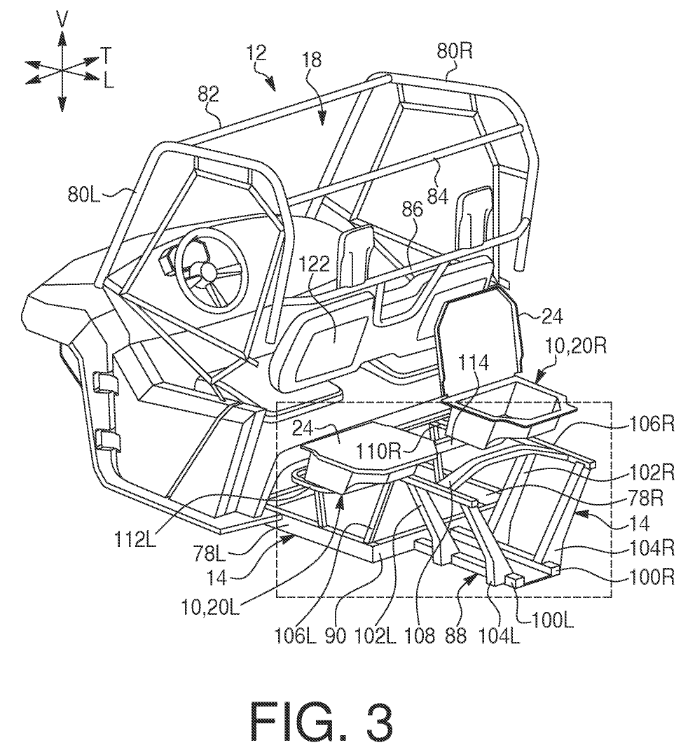

Referring to FIGS. 2 and 3, the storage system 10 can include a pair of storage bins 20L, 20R. The left storage bin 20L can be located on a left side of the vehicle 12 in a transverse direction T of the vehicle 10 and the right storage bin 20R can be located on a right side of the vehicle 12 in the transverse direction T. The storage bins 20L, 20R can be identical or substantially identical to each other (or substantially symmetrical with respect to each other) such that one of ordinary skill would perceive the storage bins 20L, 20R as being identical to each other. Thus, the base 22 and the lid 24 can have left/right compatibility.

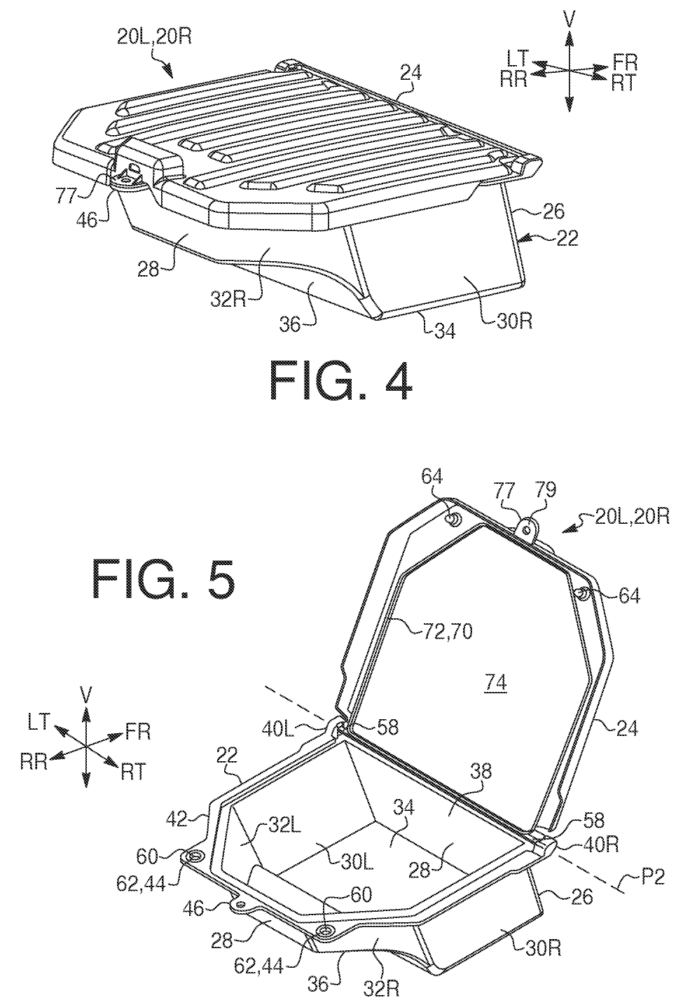

Each of the storage bins 20L, 20R can include a base 22 and a lid 24. The base 22 can be mounted onto the frame assembly 14 by any appropriate manner such as, but not limited to threaded fasteners, rivets, clamps, clips, adhesive, welding, staking or any combination of the connection structures. The lid 24 can be pivotally connected to the base 22 and movable relative to the base 22 between a closed position and an opened position. FIG. 4 shows the lid 24 in the closed position, FIG. 5 shows the lid 24 in the opened position, FIGS. 2 and 3 show the lid 24 of the right storage bin 20R in the opened position, and FIGS. 1-3 show the lid 24 of the left storage bin 20L in the closed position.

The tilt bed 16 can be pivotally connected to the frame assembly 14 and movable between a lowered position and a dump position. FIG. 1 shows the tilt bed 16 in the lowered position and FIG. 2 shows the tilt bed 16 in the dump position. That is, the tilt bed 16 can have a first orientation relative to the frame assembly 14 and a second orientation relative to the frame assembly 14 that is different from the first orientation. The tilt bed 16 can occupy a space that is immediately above the lids 24 of the storage bins 20L, 20R if the tilt bed 16 is in the lowered position and the lids 24 are in the closed position. The tilt bed 16 can vacate the space that is immediately above the lids 24 of the storage bins 20L, 20R if the tilt bed 16 is in the dump position and the lids 24 are in the closed position.

Referring to FIG. 1, the tilt bed 16 can obstruct movement of the lid 24 from the closed position to the opened position if the tilt bed 16 is in the lowered position. That is, the lid 24 can abut the tilt bed 16 if the tilt bed is in the lowered position and the lid 24 is moved toward the opened position from the closed position. Referring to FIGS. 2 and 3, the lid 24 can pivot into and out of the space that is immediately above the lid 24 if the lid 24 moves into or out of the opened position and the tilt bed 16 is in the dump position. The lid 24 can obstruct movement of the tilt bed from the dump position to the lowered position if the lid 24 is in the opened position.

Referring to FIGS. 1 and 2 collectively, the tilt bed 16 can pivot about a bed axis P1 that extends in the transverse direction T. The tilt bed 16 can pivot away from the passenger compartment 18 and the storage bins 20L, 20R if the tilt bed 16 moves from the lowered position (FIG. 1) toward the dump position (FIG. 2).

The tilt bed 16 can include a floor 116 that includes a front end 118 and a rear end 120 that is spaced away from the front end 118 in the longitudinal direction L if the tilt bed 16 is in the lowered position. The front end 118 can be adjacent to the frame assembly 14 if the tilt bed 16 is in the lowered position. The rear end 120 can be lower than the front end 118 in the vertical direction V if the tilt bed 16 is in the dump position.

Referring to FIGS. 4 and 5, the storage bins 20L, 20R can include a front-rear direction FR-RR, a left-right direction LT-RT and a vertical direction V. The front-rear direction FR-RR, the left-right direction LT-RT and the vertical direction V can correspond to the longitudinal direction L, the transverse direction T and the vertical direction V of the vehicle 12, respectively, when the storage bins 20L, 20R are mounted on the frame assembly 14.

Referring to FIG. 5, the lid 24 can pivot about a lid axis P2. The lid axis P2 can extend in the left-right direction LT-RT of the storage bins 20L, 20R. The pivot axis P2 can be adjacent to the passenger space 18 when the storage bin 20L or 20R is mounted on the frame assembly 14. The tilt bed 16 can pivot away from the lid axis P2 if the tilt bed 16 moves toward the dump position. The lid 24 can pivot away from the bed axis P1 and toward the passenger space 18 if the lid moves toward the opened position as shown by the lid 24 of the right storage bin 20R in FIGS. 2 and 3.

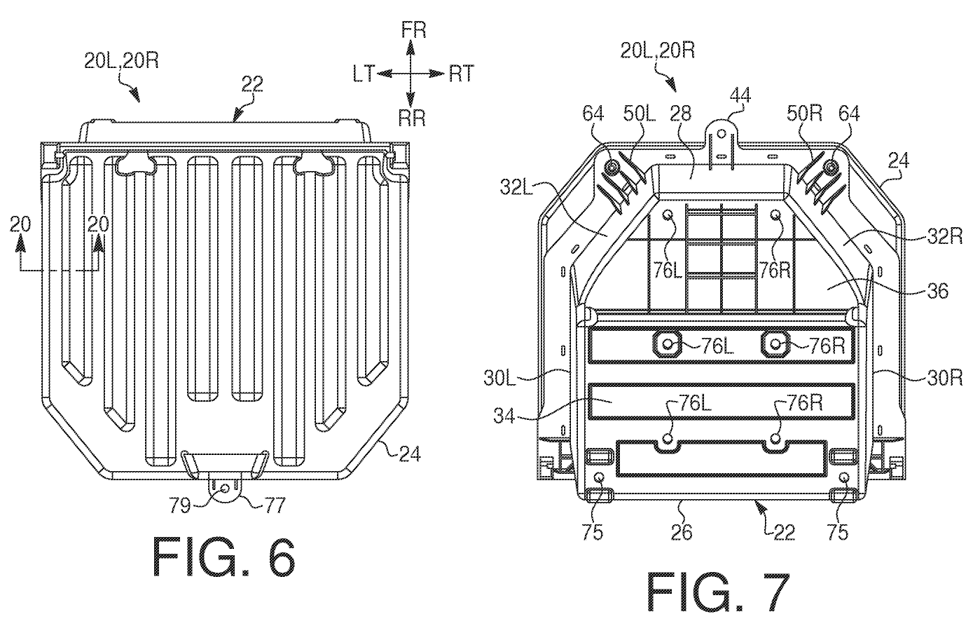

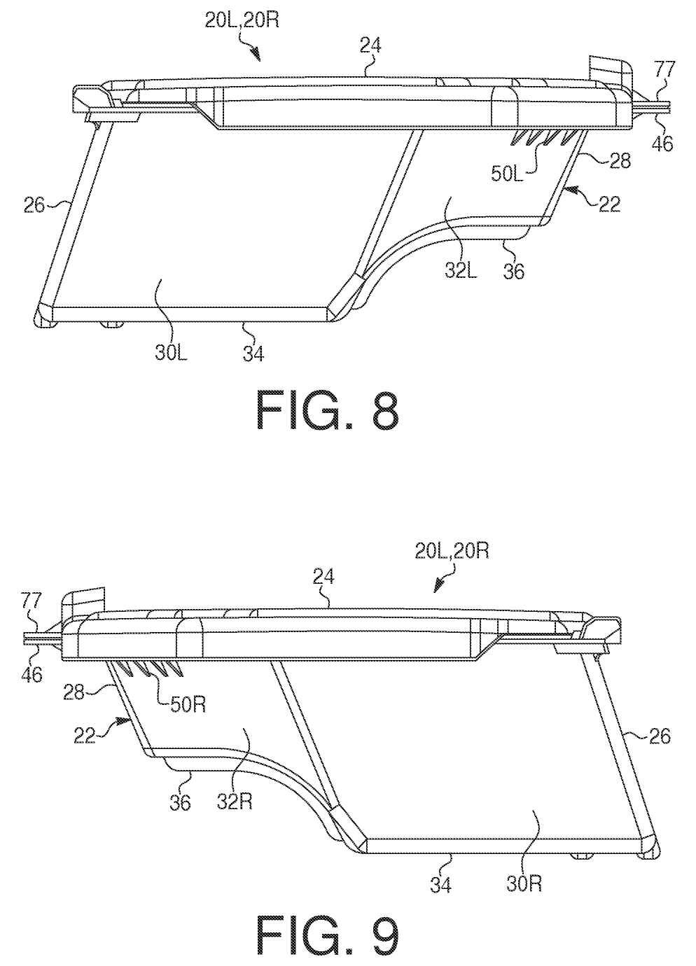

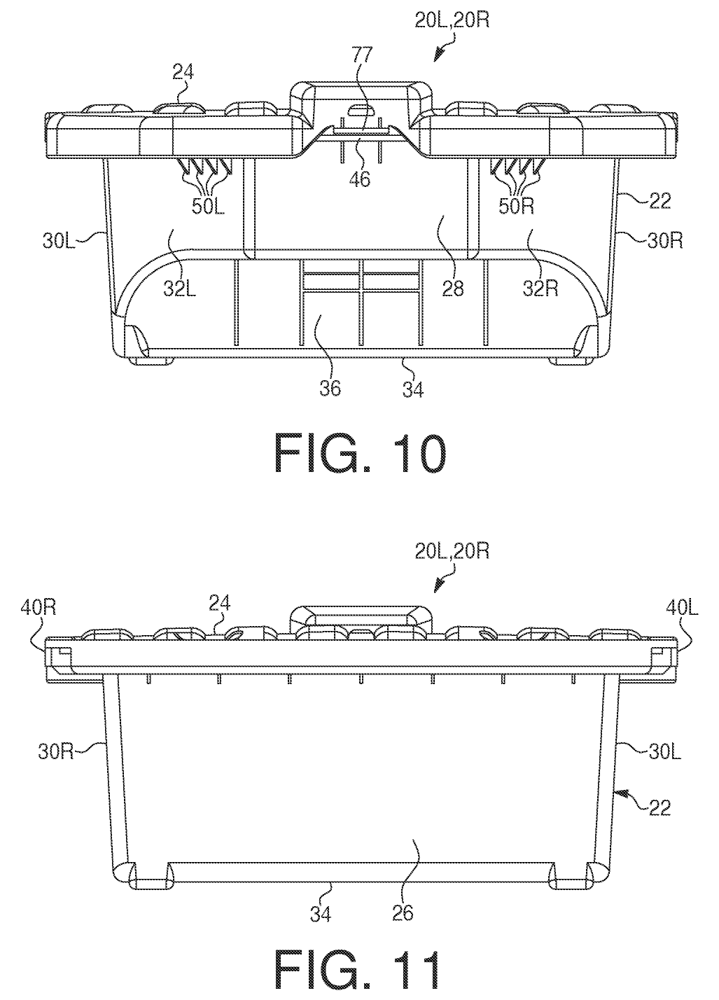

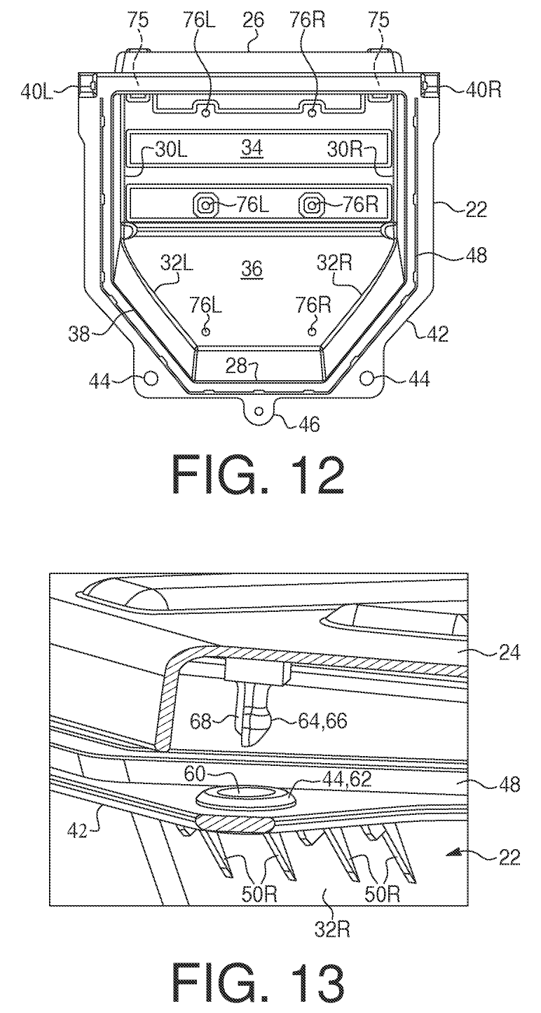

Referring to FIGS. 4-11, the storage bins 20L, 20R can be symmetrical in the left-right direction LT-RT about an axis that extends in the front-rear direction FR-RR, and asymmetrical the front-rear direction FR-RR and the vertical direction V. The base 22 can include a front wall 26, a rear wall 28, a pair of side walls 30L, 30R, a pair of angled walls 32L, 32R, a flat bottom wall 34, a contoured bottom wall 36, an opening 38 (FIGS. 5 and 12), a pair of hinge bearings 40L, 40R, a flange 42 (FIGS. 5, 7 and 12), a pair of latch receptacles 44 (FIGS. 5 and 12), a lock tab 46, a sealing wall 48 (FIG. 12) and a plurality of ribs 50L, 50R. The base 22 can be a single, homogenous structure.

The front wall 26 and the rear wall 28 can extend generally along the left-right direction LT-RT, be inclined with respect to the vertical direction V, and spaced away from each other in the front-rear direction FR-RR. Each of the front wall 26 and the rear wall 28 can be connected to and extend from the flat bottom wall 34.

The side walls 30L, 30R can extend generally along the front-rear direction FR-RR, be inclined with respect to the vertical direction V, and spaced away from each other in the left-right direction LT-RT. Each of the side walls 30L, 30R can be connected to and extend from the front wall 26, the flat bottom wall 34 and the contoured bottom wall 36.

The angled walls 32L, 32R can be generally inclined with respect to each of the vertical direction V, the left-right direction LT-RT and the front-rear direction FR-RR. The angled walls 32L, 32R can be spaced away from each other in the left-right direction LT-RT. Each of the angled walls 32L, 32R can be connected to and extend from the contoured bottom wall 36, the rear wall 28 and respective one of the side walls 30L, 30R.

The walls 26, 28, 30L, 30R, 32L, 32R can bound the opening 38. The lid 24 can selectively close and open the opening if the lid 24 is in closed position and the opened position, respectively. The lid 24 and the base 22 can bound an enclosed storage space if the lid 24 is in the closed position.

The flat bottom wall 34 can be spaced away from and oppose the opening 38 and the flange 42 in the vertical direction V. The flat bottom wall 34 can extend in the left-right direction LT-RT and the front-rear direction FR-RR.

The contoured bottom wall 36 can be connected to and extend from each of the flat bottom wall 34 and side walls 30L, 30R and the angled walls 32L, 32R. The contoured wall 36 can include a curved portion that is connected to and extends from the flat bottom wall 34 and a flat portion that extends from each of the rear wall 28, the angled walls 32L, 32R and the curved portion of the contoured bottom wall 36. The flat portion of the contoured bottom wall 36 can be spaced away from and oppose the opening 38 and the flange 42 in the vertical direction V. The flat portion of the contoured bottom wall 36 can be closer to the opening 38 than the flat bottom wall 34 is to the opening in the vertical direction V.

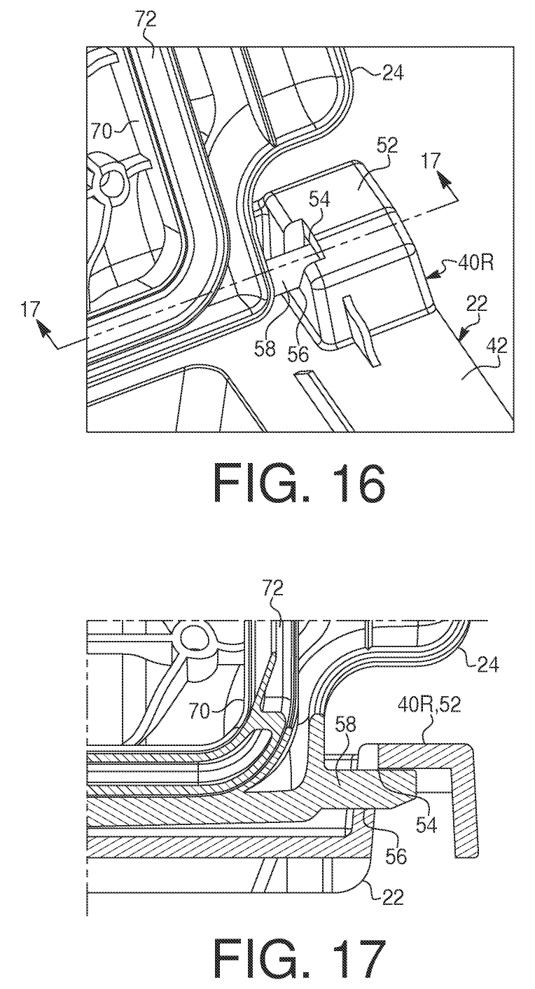

The hinge bearings 40L, 40R can support the lid 24 in the closed position, the opened position, and as the lid 24 moves between the closed position and the opened position. Referring to FIGS. 16 and 17, each of the hinge bearings 40L, 40R can include a housing 52, an opening 54 in the housing 52, and a support 56 adjacent to the opening 54. The arrangement of the housing 52, the opening 54 and the support 56 for the left hinge bearing 40L can be a mirror image of the arrangement shown in FIGS. 16 and 17.

The lid 24 can include a pair of pins 58. A respective one of the pins 58 can abut a respective one of the supports 56 and extend through a respective one of the openings 54 and into a respective one of the housings 52.

The flange 42 can surround the opening 38, extend along each of the walls 26, 28, 30L, 30R, 32L, 32R, and protrude away from each of the walls 26, 28, 30L, 30R, 32L, 32R.

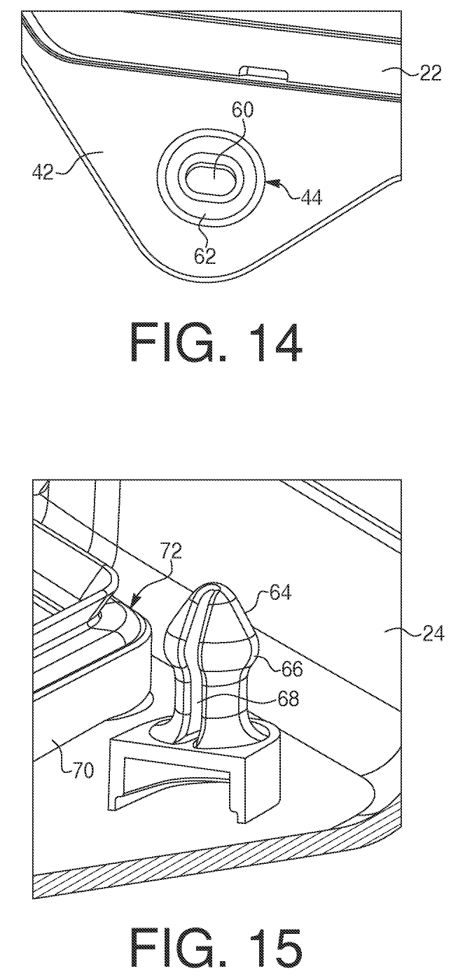

Referring to FIGS. 5 and 12-14, the latch receptacles 44 can be located on the flange 42. Each of the latch receptacles 44 can include a through hole and a rubber grommet 62 that is mounted in the through hole. The rubber grommet 62 can include a through hole 60.

Referring to FIG. 5, 7, 13 and 15, the lid 24 can include a pair of latches 64. A respective one of the latches 64 can selectively engage with and disengage from the grommet 62 of a respective one of the latch receptacles 44. Referring to FIGS. 13 and 15, each of the latches 64 can include an enlarged portion 66 and a slit 68. The enlarged portion 66 can be larger than the diameter of the through hole 60 of the latch receptacle 44. The slit 68 can facilitate elastic deformation of the latch 60 so that the enlarged portion 66 can pass through the through hole 60 if the lid 24 is moved into the closed position. The enlarged portion 66 can maintain the lid 24 in the closed position. The enlarged portion 66 can elastically deform and exit from the latch receptacle via the through hole 60 if the lid 24 is moved away from the closed position.

Referring to FIGS. 8, 9, 10 and 13, the base 22 can include a plurality of ribs 50L, 50R. The left ribs 50L can be connected to and extend from the flange 42 to the left angled wall 32L and the right ribs 50R can be connected to and extend from the right angled wall 32R. The left ribs 50L can be adjacent to the latch receptacle 44 that is in the left side of the base 22 and the right ribs 50R can be adjacent to the latch receptacle 44 that is on the right side of the base 22. The ribs 50L, 50R can reinforce the flange 42 against undesirable deformation during latching/unlatching of the lid 24 to/from the base 22.

Referring to FIG. 12, the sealing wall 48 can follow a perimeter outline of the walls 26, 30L, 30R, 32L, 32R and can be located on the flange 42 at a position that is spaced outwardly from the opening 38. The sealing wall 48 can protrude from and be connected to the flange 42.

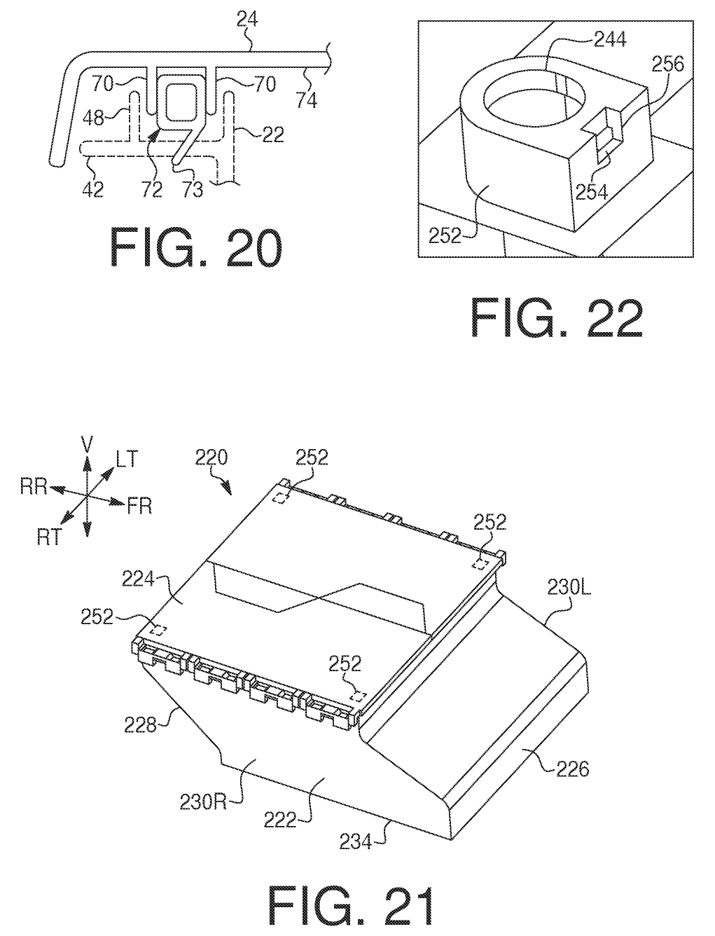

Referring to FIGS. 5, 15-17 and 20, the lid 24 can include a channel 70 and a lip seal 72 mounted in the channel 70. The lid 24 can include an inner surface 74 (FIGS. 5 and 20) and the channel 70 can include a pair of walls that protrude from the inner surface 74 and are spaced away from each other. The lip seal 72 can be press-fit into the channel 70 and retained on the lid 24 by press-fit with the channel 70. The lip seal 72 can surround an area of the inner surface 74.

Referring to FIG. 20, the lip seal 72 can include a lip 73 that engages the flange 42 at a location that is between the sealing wall 48 and the opening 38. The base 22 is shown in phantom in FIG. 20 for simplicity and clarity of the drawing. If the lid 24 is locked into the closed position by the latches 64 engaging the latch receptacles 44, then the lip 74 can abut the flange 42 and be deformed by the flange 42. Thus, the lip seal 72 can seal the enclosed storage space against dirt, debris and fluids.

Referring to FIGS. 7 and 12, the base 22 can include a plurality of mounting holes 75, 76L, 76R that pass through the flat bottom wall 34. The common mounting holes 75 are obstructed from view in Fig, 12 by the flange 42 of the base 22. The base 22 can be connected to the frame assembly 14 with any appropriate fastener such as, but not limited to a threaded fastener, a rivet, a clip, a clamp, or a stake that passes through a respective one of the mounting holes 76. For the left storage bin 22L, a respective connector can pass through each of the common mounting holes 75 and each of the right mounting holes 76R. The left storage bin 22L can include a respective rubber plug inserted into each of the left mounting holes 76L to seal the left mounting holes 76L. For the right storage bin 22R, a respective connector can pass through each of the common mounting holes 75 and each of the left mounting holes 76L. The right storage bin 22R can include a respective rubber plug inserted into each of the right mounting holes 76R to seal the left mounting holes 76R. The rubber plugs can be removed to allow drainage of any fluid that has collected in the storage bins 22L, 22R.

Referring to FIGS. 4-6 and 8-10, the lid 24 can include a second lock tab 77 that overlaps the first lock tab 46 of the base 22 if the lid 24 is in the closed position. The first lock tab 46 can include a first through hole 47 and the second lock tab 77 can include a second through hole 79 that aligns with the first through hole 47. A bolt of a padlock (not shown) can pass through the through holes 47, 79 to lock the lid 24 in the closed position.

Thus, the storage system 10 can provide additional enclosed storage space that is outside of the passenger space 18 and does not interfere with the movement of the tilt bed 16. Further, the storage system 10 can seal the enclosed storage space against dirt debris and fluids. Further still, the storage system 10 can be configured to hinder or prevent unauthorized removal of the contents in the enclosed storage space.

Returning to FIGS. 1-3, the frame assembly 14 can include a pair of main frame members 78L, 78R, a plurality of tube members 80L, 80R, 82, 84, 86, subframe 88 and cross member 90. The tube members 80L, 80R, 82, 84, 86 can be referred to as frame members.

The main frame members 78L, 78R can extend in the longitudinal direction L and be space away from each other in the transverse direction T. The cross member 90 can be connected to and extend from each of the main frame members 78L, 78R in the transverse direction T. The cross member 90 can be connected to each of the main frame members 78L, 78R by any appropriate manner such as, but not limited to, threaded fasteners, rivets, clamps, clips, welds, adhesives, or any combination of these connecting structures.

A respective one of side tube members 80L, 80R can be connected to a respective one of the main frame members 78L, 78R by any appropriate manner such as, but not limited to, threaded fasteners, rivets, clamps, clips, welds, adhesives, or any combination of these connecting structures. The side tube members 80L, 80R can bound the left side and the right side, respectively, of the passenger space 18. The side tube members 80L, 80R can be assembled from a plurality of cylindrical tubes that are connected together by any appropriate manner such as, but not limited to, threaded fasteners, rivets, clamps, clips, welds, adhesives, or any combination of these connecting structures. A least one of the tubes of each of the side tube members 80L, 80R is omitted from FIGS. 1-3 at a location that is adjacent to the storage bins 20L, 20R for clarity and simplicity of the drawings.

The cross tube members 82, 84, 86 can be connected to and extend from each of the side tube members 80L, 80R in the transverse direction T. The cross tube members 82, 84, 86 can be connected to both of the side tube members 80L, 80R by any appropriate manner such as, but not limited to, threaded fasteners, rivets, clamps, clips, welds, adhesives, or any combination of these connecting structures. The first cross tube member 82 can span across the top of the passenger space 18 and the second and third cross tube members 84, 86 can bound the rear of the passenger space 18.

A portion the main frame members 78L, 78R can extend away from the passenger space 18 in the longitudinal direction L, and the cross member 90 can be spaced away from the passenger space 18. Referring to FIG. 1, the vehicle 12 can include a power source 92 that is mounted on this portion of the main frame members 78L, 78R. The power source 92 is shown schematically and in phantom in FIG. 1. The power source 92 can be an internal combustion engine, an electric motor or a hybrid of an internal combustion engine and an electric motor. The power source 92 configured as an internal combustion engine or a hybrid power source can have the engine output axis oriented in the longitudinal direction L or in the traverse direction T of the vehicle 12. In the exemplary embodiment of FIG. 1, the power source 92 is configured as a longitudinally-oriented, mid-mounted internal combustion engine.

The power source 92 can be located underneath the tilt bed 16 in the vertical direction V. The storage bins 20L, 20R can be mounted to the frame assembly 14 at a location that is between the tilt bed 16 and the power source 92 in the vertical direction V.

The subframe 88 can be connected to the cross member 90 by any appropriate manner such as, but not limited to, threaded fasteners, rivets, clamps, clips, welds, adhesives, or any combination of these connecting structures. The subframe 88 can extend away from the cross member 90 in the longitudinal direction L and toward a rear end of the vehicle 12.

The vehicle 12 can include a pair of front wheels 94 and a pair of rear wheels 96. The front and rear wheels 94, 96 on the right side of the vehicle 12 are obstructed from view in FIG. 1 and can mirror the location of the left side wheels 94, 96. A respective suspension assembly can connect a respective one of the wheels 94, 96 to the frame assembly 14.

The vehicle 12 can include a transmission and final drive assembly 98. The transmission and final drive assembly 98 is shown schematically and in phantom in FIG. 1. The transmission and final drive assembly 98 can be referred to as a transaxle. The transaxle 98 can include a plurality of selectable gear ratios and a differential drive assembly. The transaxle 98 can be mounted on the subframe 88 and driven by the power source 92. The transaxle 98 can split the input received from the power source 92 and transmit an output that drives each of the rear wheels 96.

Alternate embodiments of the vehicle 12 can include a transfer case that is driven by the power source 92 and splits the input received from the power source 92 and transmits an output that drives the transaxle 98 and a second differential drive assembly at the front of the vehicle 12. The second differential drive can split the input received from the transfer case and transmit an output that drives the front wheels 94.

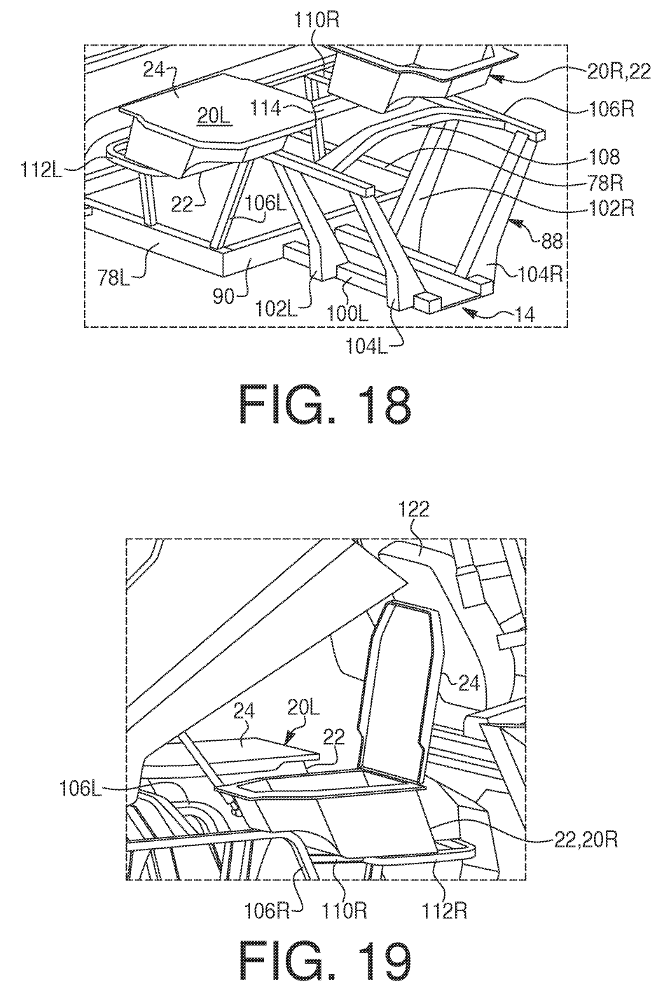

The subframe 88 can connect the rear wheels to the main frame members 78L, 78R. Referring to FIGS. 3 and 18, the subframe 88 can include a pair of longitudinal members 100L, 100R and a plurality of frame members 102L, 102R, 104L, 104R, 106L, 106R, 108.

The longitudinal members 100L, 100R can be connected to the cross member 90 by any appropriate manner such as, but not limited to, threaded fasteners, rivets, clamps, clips, welds, adhesives, or any combination of these connecting structures. The longitudinal members 100L, 100R can extend away from the cross member 90 in the longitudinal direction L and toward a rear end of the vehicle 12. The longitudinal members 100L, 100R can be spaced away from each other in the transverse direction T.

A respective one of the first frame members 102L, 102R can be connected to and extend away from a respective one of the longitudinal members 100L, 100R. The first frame members 102L, 102R can be connected to the longitudinal members 100L, 100R by any appropriate manner such as, but not limited to, threaded fasteners, rivets, clamps, clips, welds, adhesives, or any combination of these connecting structures. The first frame members 102L, 102R can be inclined relative to the vertical direction V and transverse direction T. The first frame members 102L, 102R can be configured to be connected to the suspension assembly for the rear wheels 96.

A respective one of the second frame members 104L, 104R can be connected to and extend away from a respective one of the longitudinal members 100L, 100R. The second frame members 104L, 104R can be connected to the longitudinal members 100L, 100R by any appropriate manner such as, but not limited to, threaded fasteners, rivets, clamps, clips, welds, adhesives, or any combination of these connecting structures. The second frame members 104L, 104R can be inclined relative to the vertical direction V and transverse direction T. The second frame members 104L, 104R can be configured to be connected to the suspension assembly for the rear wheels 96.

A respective one of the third frame members 106L, 106R can be connected a respective one of the first frame members 102L, 102R and respective one of the second frame members 104L, 104R. The third frame members 106L, 106R can be connected to the first frame members 102L, 102R and the second frame members 104L, 104R by any appropriate manner such as, but not limited to, threaded fasteners, rivets, clamps, clips, welds, adhesives, or any combination of these connecting structures. The third frame members 106L, 106R can include a first portion that extends in the longitudinal direction L and a second portion that is inclined with respect to the longitudinal direction L. The first portion of the third frame members 106L, 106R can be connected to the first frame members 102L, 102R and the second frame members 104L, 104R. A respective one of the inclined portions can be connected to a respective one of the main frame members 78L, 78R by any appropriate manner such as, but not limited to, threaded fasteners, rivets, clamps, clips, welds, adhesives, or any combination of these connecting structures.

The fourth frame member 108 can be connected to and extend from the longitudinal portion of each of the third frame members 106L, 106R in the transverse direction T. The fourth frame member 108 can be connected to the third frame members 106L, 106R by any appropriate manner such as, but not limited to, threaded fasteners, rivets, clamps, clips, welds, adhesives, or any combination of these connecting structures.

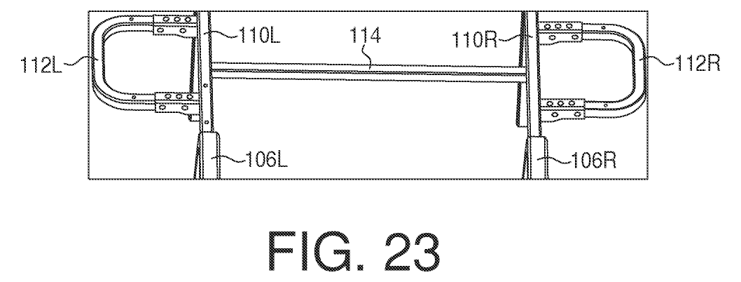

Referring to FIGS. 3, 18 and 23 collectively, the frame assembly 14 can include a plurality of support members 110L, 110R, 112L, 112R, 114.

A respective one of the first support members 110L, 110R can be connected to and extend from the inclined portion of a respective one of the third frame members 106L, 106R in the longitudinal direction L. The first support members 110L, 110R can be connected to the third frame members 106L, 106R by any appropriate manner such as, but not limited to, threaded fasteners, rivets, clamps, clips, welds, adhesives, or any combination of these connecting structures. The first support members 110L, 110R can be spaced away from the main frame members 78L, 78R and the tilt bed 16 in the vertical direction V.

A respective one of the second support members 112L, 112R can be connected to and extend from a respective one of the first support members 110L, 110R in the transverse direction T. The second support members 112L, 112R can be connected to first support members 110L, 110R by any appropriate manner such as, but not limited to, threaded fasteners, rivets, clamps, clips, welds, adhesives, or any combination of these connecting structures. The second support members 112L, 112R can be spaced away from the main frame members 78L, 78R and the tilt bed 16 in the vertical direction V.

The third support member 114 can be connected to and extend from the first support members 110L, 110R in the transverse direction T. The third support member 114 can be connected to first support members 110L, 110R by any appropriate manner such as, but not limited to, threaded fasteners, rivets, clamps, clips, welds, adhesives, or any combination of these connecting structures. The third support member 114 can be spaced away from the main frame members 78L, 78R and the tilt bed 16 in the vertical direction V.

The base 22 of the left storage bin 20L can be mounted onto any one or any combination of the left first support member 110L, the left second support member 112L and the third support member 114. The base 22 of the right storage bin 20R can be mounted onto any one or any combination of the right first support member 110R, the right second support member 112R and the third support member 114. The base 22 can be connected to the appropriate one(s) of the support members 110L, 110R, 112L, 112R, 114 by any appropriate manner such as, but not limited to, threaded fasteners, rivets, clamps, clips, stakes, or any combination of these connecting structures.

Referring to FIGS. 1-3, the vehicle 12 can include a seat back 122 that is connected to the frame assembly 14 by any appropriate manner. Referring to FIGS. 2, 3 and 19, each of the lids 24 can abut the seat back 122 if the lid 24 is in the opened position.

FIG. 21 illustrates an alternate embodiment of a storage bin 220. The storage bin 220 can include a base 222 and a lid 224. The lid 224 can be pivotally connected to the base 222 such that the lid 224 is movable between a closed position shown in Fig, 21 and an opened position. The base 222 can have a generally rectangular shape with a front wall 226, a rear wall 228, a pair of side walls 230L, 230R and a bottom wall 234. Each of the front wall 226 and the rear wall 228 can be a contoured wall.

The base 222 can include a plurality of housings 252, one adjacent to each corner of the lid 224. Each of the housings 252 can include a latch receptacle 244, a support 254 and an opening 256. The openings 256 of the pair of housings 252 above the left side wall 230L can face each other in the in the front-rear direction FR-RR and the pair of housings 252 above the right side wall 230R can face each other in the front-rear direction FR-RR.

The lid 224 can include a pair of pins and a pair of latches. The pins can be configured to be the same as or similar to the pins 58 shown in FIGS. 16 and 17. The latches can be configured to be the same as or similar to the latch 64 shown in FIGS. 13 and 15. The pins can be located along a first side of the lid 224 that extends in the front-rear direction FR-RR and the latches can be located on the second side of the lid 224 that extends in the front-rear direction FR-RR, where the second side is opposite to the first side.

If the base 222 is mounted on the left side of the vehicle 12, the pins of the lid 224 can be inserted into the openings in the housings 252 that are above the right side wall 230R and the latches can be inserted into the latch receptacles 244 that are in the housings above the left side wall 230L. If the base 222 is mounted on the right side of the vehicle 12, the pins of the lid 224 can be inserted into the openings in the housings 252 that are above the left side wall 230L and the latches can be inserted into the latch receptacles 244 that are in the housings above the right side wall 230R. Thus, the base 222 and the lid 224 can have left/right compatibility.

The lid 224 can pivot about an axis that extends in the longitudinal direction L of the vehicle 12 if the storage bin 220 is mounted onto the frame assembly of the vehicle 12. The lid 224 can pivot toward the center of the vehicle 12 in the transverse direction T and toward the other of the storage bins 220. The lid 224 can pivot 180 degrees between the closed position and the opened position.

The bin 220 can be connected to any of the support members 110L, 110R, 112L, 112R, 114.

While certain embodiments of the invention are described above, it should be understood that the invention can be embodied and configured in many different ways without departing from the spirit and scope of the invention.

Instead of the two separate storage bins 20L, 20R, alternate embodiments of the storage system 10 can include a single storage bin that extends from the left second support member 112L to the right second support member 112R. Instead of extending to and from the second support members 112L, 112R, the single storage bin can be located on the right side of the frame assembly 14, or on the left side of the frame assembly 14, or centrally located on the frame assembly 14 with respect to the transverse direction T and spaced away from the second support members 112L, 112R.

Instead of being spaced away from each other in the transverse direction T, alternate embodiments of the storage system 10 can include a pair of storage bins that abut each other in the transverse direction T.

Instead of the irregular shaped base 22, alternate embodiments of the storage system 10 can omit the angled walls 32L, 32R and the base 22 can have a regular rectangular shape. In exemplary embodiments, the left storage bin 20L can be a mirror image of the right storage bin 20R. In other exemplary embodiments the left storage bin 20L can have a shape that is unrelated to the shape of the right storage bin 20R.

In alternate embodiments, the lid 24 can be omitted from one or both of the storage bins 20L, 20R. The floor 116 of the tilt bed 16 can be configured to close the storage bins 20L, 20R if the lids 24 are omitted. Access to the contents of either of the storage bins 20L, 20R can be obtained by moving the tilt bed 16 to its tilted position.

In alternate embodiments, the tilt bed 16 can include an opening in the floor 116 and the lid can be mounted on the tilt bed 16 instead of the base 22. The opening in the floor 116 of the tilt bed 16 can be complementary to the opening 38 of the base 22. The lid 24 can form a portion of the floor 116 when the lid 24 closes the opening in the floor 116. The lid 24 can be removable from or movable relative to the floor 116 of the tilt bed 16 to gain access to one of the storage bins 20L, 20R when the tilt bed 16 is in the lowered position to permit access to the contents of either of the storage bins 20L, 20R when the tilt bed 16 is in its lowered position. The lid 24 can cover one or both of the storage bins 20L, 20R if the lid 24 is in the closed position.

Instead of being made as a solid, relatively rigid object as shown in the drawings and described above, alternate embodiments can include the lid 24 configured as a net that extends across the opening 38 of the base 22 to enclose the contents of the storage bins 20L, 20R. One or more fastening structures such as, but not limited to, mating snap fasteners, hook and loop fasteners, clips, clamps, etc. can selectively connect and disconnect the net and the base 22.

Instead of being configured as a single piece, alternate embodiments can include the lid 24 formed by two or more lid portions that cooperate with each other to selectively open and close the opening 38 of the base 22.

Instead of a single, homogenous structure, the base 22 can be assembled from a plurality of separate components that are connected together in any appropriate manner. The separate components can be made of the same or similar material or of dissimilar materials.

Instead of being spaced above the main frame members 78L, 78R in the vertical direction V, alternate embodiments of the storage system 10 can include the storage bins 20L, 20R mounted directly onto the main frame members 78L, 78R or located immediately adjacent to the main frame members 78L, 78R with respect to the vertical direction V.

Alternate embodiments can include the latch receptacles 44 on the lid 24 and the latches 64 on the bin 22. Instead of the latch assembly 55, 64, one of the base 22 and the lid 24 can include an elastically deformable latch receptacle that is cantilevered to the one of the base 22 and the lid 24 and the other of the base 22 and the lid 24 can include a projection that protrudes away from the other of the base 22 and the lid 24. The projection can extend through the through hole and can engage the latch if the lid 24 is in the closed position and the latch can be elastically deformed to move the latch out of engagement with the projection so that the lid 24 can be move away from the closed position.

Instead of the latch receptacle 44 and the latch 64, alternate embodiments can include a latch that is rotatably mounted on one of the lid 24 and the base 22 and is rotated to engage a mating structure on the other of the lid 24 and the base 22 to lock the lid 24 in the closed position. In other alternate embodiments, one of the lid 24 and the base 22 can include a movable clamp that selectively engages and disengages a mating structure on the other of the lid 24 and the base 22 to selectively lock the lid 24 in the closed position.

Instead of the hinge bearings 40L, 40R and the pins 58, alternate embodiments can include a pair of elastically deformable c-clamps on one of the base 22 and the lid 24 and an axle rod on the other of the base 22 and the lid 24 that snap-fits into the c-lamps.

In alternate embodiments, the sealing wall 48, the channel 70 and the lip seal 70 can be omitted if it is desirable to provide a storage bin 20 that is not sealed against water, mud, dust, etc.

Alternate embodiments of the storage bin can include a thermal insulation layer that lines the inside of the base 22 and the inner surface 74 of the lid 24 to create a cold storage box. In other alternate embodiments, the base 22 and the lid 24 can be formed using a thermal insulating material to create a cold storage box. In alternate embodiments, one or both of the storage bins 20L, 20R can be configured as a cold storage box.

Instead of mounting the storage bins 20L, 20R on the frame assembly 14, alternate embodiments can include at least one of storage bins 20L, 20R mounted on the tilt bed 16 that extends in the vertical direction V from the surface of the floor 116 of the tilt bed 16 that faces the frame assembly 14. The storage bin(s) can move with the tilt bed 16 as the tilt bed 16 moves between the lowered position and the dump position. Access to the storage bin(s) can be restricted in any appropriate manner if the tilt bed 16 is moved away from the lowered position. The tilt bed 16 can include one or more lids that form a portion of the floor 116 and selectively open and close the openings 38 of the storage bins 20L, 20R. The lid(s) of the floor 116 can be removable from the tilt bed 16 or movable to a stationary portion of the floor 116 to permit access to the storage bins 20L, 20R. The storage bins could also include a lid or lids located in side walls or a bottom wall if the bin(s) are connected to the tilt bed 16.

Alternate embodiments can include one of the storage bins 20L, 20R mounted on the frame assembly 14, as described above, and another one of the storage bins 20L, 20R mounted on the tilt bin 16, as described above.

Alternate embodiments can include a single storage bin mounted on the tilt bed and extending in the vertical direction V from the surface of the floor 116 that faces the frame assembly 14. The single storage bin can be centered in the transverse direction T or offset to the left or right with respect to the transverse direction T.

In alternate embodiments with at least one storage bin mounted on the tilt bed described above, the storage bin can include an opening in the base that faces in the transverse direction T and a lid mounted on the base that closes the opening. Thus, a user can access the inside of the storage bin in any position of the tilt bed 16 between and including the lowered position and the dump position.

In alternate embodiments in which electrical power is relied upon to propel the vehicle 12, the vehicle 12 can include a single electric motor that drives both rear wheels 96. The gear transmission can be omitted and the electric motor can drive the rear differential drive assembly. In other alternate embodiments, the vehicle 12 can include two electric motors, one for each wheel. A respective one of the electric motors can directly drive a respective one of the rear wheels directly or via a single ratio geartrain.

In another embodiment, the lid 24 can be prevented from opening by a separate lock provided to keep the tilt bed 16 from moving with respect to the frame assembly 14 when the vehicle 12 is not being operated. For example, the tilt bed 16 can be configured to only be operational to move from the closed position to the opened position when the vehicle ignition is powered, or when a separate lock is released either electronically or mechanically from a vehicle control panel or controller. Locking and release of lock of the tilt bed 16 (or lid 24) can be provided within the control system of the vehicle 12, or can be remotely actuated wirelessly via an application that requires password authentication or other means to ensure a proper or authorized user can unlock either the tilt bed 16 or lid 24.

What is claimed is:

1. A vehicle, comprising:
a frame assembly;
a tilt bed pivotally connected to the frame assembly and movable between,
a lowered position where the front end has a first orientation relative to frame assembly, and
a dump position where the tilt bed has a second orientation relative to the frame assembly, the second orientation is different from the first orientation; and
a storage bin located underneath the tilt bed in a vertical direction of the vehicle, the storage bin includes,
a base mounted onto the frame assembly, the base includes a storage space and an opening, and
a lid pivotally connected to the base and movable between,
a closed position where the lid closes the opening, and
an opened position where the lid exposes the opening, wherein
the tilt bed is configured to impede movement of the lid into the opened position if the tilt bed is in the lowered position, and to permit the lid to move into the opened position if the tilt bed is in the dump position.

2. The vehicle according to claim 1, wherein the lid abuts the tilt bed if the tilt bed is in the lowered position and the lid is moved away from the closed position and toward the opened position.

3. The vehicle according to claim 1, wherein
the tilt bed pivots about a bed axis, and
the lid pivots about a lid axis and the lid pivots away from the bed axis if the lid is moved from the closed position to the opened position.

4. The vehicle according to claim 3, wherein
the frame assembly includes:
a pair of main frame members that along a longitudinal direction of the vehicle and are spaced away from each other in the transverse direction;
a plurality of tube members connected to the main frame members and bounding a passenger space; and
a support member that is connected to at least one of the main frame members, spaced away from the at least one of the main frame members in a vertical direction of the vehicle, and spaced away from the plurality of tube members in the longitudinal direction, and
the base is mounted onto the support member, spaced away from the at least one of the main frame members in the vertical direction, and spaced away from the tube members in the longitudinal direction.

5. The vehicle according to claim 4, wherein both of the bed axis and the lid axis extend in the transverse direction.

6. The vehicle according to claim 1, wherein
the frame assembly includes a plurality of tube members that bound a passenger space,
the storage bin is spaced away from the passenger space in a longitudinal direction of the vehicle, and
the lid pivots toward the passenger space if the lid is moved toward the opened position.

7. The vehicle according to claim 1, wherein the lid includes a seal that encircles an area of the lid, the seal engages the base and seals the storage space if the lid is in the closed position.

8. The vehicle according to claim 7, wherein
the base includes a latch receptacle, and
the lid includes a latch that engages the latch receptacle if the lid is in the closed position.

9. The vehicle according to claim 1, further comprising:
a power source mounted on the frame assembly and underneath the tilt bed in a vertical direction of the vehicle; and
a plurality of wheels suspended from the frame assembly; and
a passenger space above the frame assembly in the vertical direction, wherein
the storage bin is located between the power source and the passenger space in the longitudinal direction.

10. A vehicle, comprising:
a frame assembly;
a tilt bed pivotally mounted to the frame assembly and movable between,
a lowered position where the front end has a first orientation relative to frame assembly, and
a dump position where the tilt bed has a second orientation relative to the frame assembly, the second orientation is different from the first orientation; and
a storage bin mounted onto the frame assembly and including,
a base mounted onto the frame assembly and underneath the tilt bed in a vertical direction of the vehicle, the base including a storage space and an opening, and
a lid pivotally connected to the base and movable between:
a closed position where the lid closes the opening; and
an opened position where the lid exposes the opening, wherein
the tilt bed is configured to impede movement of the lid into the opened position if the tilt bed is in the lowered position, and to permit movement of the lid into the opened position if the tilt bed is in the dump position.

11. The vehicle according to claim 10, wherein
the frame assembly includes:
a pair of main frame members that extend along a longitudinal direction of the vehicle and are spaced away from each other in a transverse direction of the vehicle; and
a plurality of tube members that bound a passenger space, at least one of the tube members is connected at least one of the main frame members,
the tilt bed pivots away from the passenger space if the tilt bed moves from the lowered position to the dump position, and
the lid pivots toward the passenger space if the lid moves from the closed position to the opened position.

12. The vehicle according to claim 11, wherein
the frame assembly includes a support member that is indirectly connected to at least one of the main frame members,
the base is mounted onto the support member, and
the base is outside of the passenger space and spaced away from the at least one of the main frame members in the vertical direction.

13. The vehicle according to claim 10, wherein
one of the base and the lid includes a hinge bearing, and
a different one of the base and the lid includes a hinge pin that is rotatably supported on the hinge bearing.

14. The vehicle according to claim 10, wherein
one of the base and the lid includes a latch receptacle, and
a different one of the base and the lid includes a latch that engages the latch receptacle if the lid is in the closed position.

15. The vehicle according to claim 10, wherein
one of the base and the lid includes a seal that encircles an area of the one of the base and the lid, and
the seal engages a different one of the base and the lid if the lid is in the closed position.

16. A vehicle, comprising:
a frame assembly;
a pair of front wheels suspended from the frame assembly and spaced away from each other in a transverse direction of the vehicle;
a pair of rear wheels suspended from the frame assembly, spaced away from each other in a transverse direction of the vehicle, and spaced away from the pair of front wheels in a longitudinal direction of the vehicle;
at least one seat supported by the frame assembly;
a power source mounted onto the frame assembly at a location that is between the seat and the pair of rear wheels in the longitudinal direction, the power source is connected to at least one of the wheels;
a tilt bed that is pivotally connected to the frame assembly and stacked above the power source in a vertical direction of the vehicle, the tilt bed is movable between,
a lowered position where tilt bed has a first orientation relative to the frame assembly, and
a dump position where the tilt bed has a second orientation relative to the frame assembly, the second orientation is different from the first orientation; and
a first storage bin mounted on the frame assembly and underneath the tilt bed in the vertical direction, the first storage bin includes:
a first base mounted onto the frame assembly and underneath the tilt bed in the vertical direction, the first base includes a first storage space and a first opening; and
a first lid pivotally connected to the first base and movable between:
a closed position where the first lid closes the first opening; and
an opened position where the first lid exposes the first opening, wherein
the tilt bed is configured to impede movement of the first lid into the opened position if the tilt bed is in the lowered position, and configured to permit movement of the first lid into the opened position if the tilt bed is in the dump position.

17. The vehicle according to claim 16, further comprising:
a second storage bin that includes:
a second base mounted onto the frame assembly and underneath the tilt bed in the vertical direction; and
a second lid pivotally connected to the second base,.

18. The vehicle according to claim 17, wherein
the tilt bed pivots about a bed axis that extends in the transverse direction,
the first lid pivots about a first lid axis that extends in the transverse direction, the first lid pivots away from the bed axis if the first lid moves from the closed position to the opened position, and
the second lid pivots about a second lid axis that extends in the transverse direction.

19. The vehicle according to claim 18, wherein
the second base includes a second storage space and a second opening, and
the second lid is movable between:
a closed position where the second lid closes the second opening; and
an opened position where the second lid exposes the second opening, and
the tilt bed is configured to impede movement of the second lid into the opened position when the tilt bed is in the lowered position, and configured to permit the second lid to move into the opened position when the tilt bed is in the dump position.

20. The vehicle according to claim 16, wherein the first storage bin is located between the power source and the tilt bed in the vertical direction.
